(19) United States
(12) Patent Application Publication
(10) Pub. No.: US 2014/0203117 A1
(43) Pub. Date: Jul. 24, 2014

(54) ELECTROSTATIC ATOMIZING APPARATUS

(71) Applicants: Takeshi Yano, Kyoto (JP); Yukari Nakano, Shiga (JP); Yutaka Uratani, Shiga (JP); Yoshio Mori, Shiga (JP)

(72) Inventors: Takeshi Yano, Kyoto (JP); Yukari Nakano, Shiga (JP); Yutaka Uratani, Shiga (JP); Yoshio Mori, Shiga (JP)

(73) Assignee: PANASONIC CORPORATION, Osaka (JP)

(21) Appl. No.: 14/239,986

(22) PCT Filed: Jul. 25, 2012
(86) PCT No.: PCT/JP2012/068798

§ 371 Date: Feb. 20, 2014

(30) Foreign Application Priority Data
Sep. 5, 2011 (JP) 2011-192701

(51) Int. Cl. B05B 5/00

(52) U.S. Cl. CPC B05B 5/001
USPC 239/690

(57) ABSTRACT

An electrostatic atomizing apparatus is provided with a discharge electrode, a water feeder for supplying water to the electrode, and a high voltage supply configured to generate a high intensity electric field to electrostatically atomize the water supplied to the discharge electrode. The electrode and the high voltage supply are held by an identical circuit substrate.

### TECHNICAL FIELD

The invention relates to an electrostatic atomizing apparatus.

### BACKGROUND ART

Japanese Patent Application Publication Number 2007-117971 (hereinafter referred to as a “Document 1”) discloses an electrostatic atomizing apparatus. The electrostatic atomizing apparatus includes a discharge electrode, a water feeder for supplying water to the discharge electrode, and a high voltage supply for generating a high intensity electric field to electrostatically atomize the water supplied to the discharge electrode.

In Document 1, the discharge electrode and a Peltier unit as the water feeder for the discharge electrode are consolidated into one atomization block (of electrical parts) that is physically separated from a block (of electrical parts) constituting the high voltage supply.

The atomization block and the block constituting the high voltage supply which are physically separated from each other are separately built in a case, which forms the electrostatic atomizing apparatus.

There is however a problem of difficulty in reducing manufacturing cost in the prior art, because the atomization block and the block constituting the high voltage supply which are physically separated from each other need to be separately built in the case to be fixed, which causes the complexity of assembly.

In addition, the atomization block and the block constituting the high voltage supply, physically separated from each other, are separately built in the case, and thereby causes a complicated shape of the case and results in difficulty in reducing a size of the case, namely a size of the electrostatic atomizing apparatus.

Moreover, it is necessary to electrically connect the atomization block and the high voltage supply in the case by, for example, complicated assembling such as attachment of harness for electrically connect the blocks, fixing the blocks to the case, and the like. As a result, the problem of difficulty in reducing manufacturing cost arises.

### SUMMARY OF INVENTION

The present invention has been achieved in view of the above circumstances, and an object thereof is to provide an electrostatic atomizing apparatus which facilitates assembly into a case, an electrical apparatus or the like, and enables downsizing.

An electrostatic atomizing apparatus of the present invention comprises a discharge electrode (2), a water feeder (3) configured to supply water to the discharge electrode (2), and a high voltage supply (4) configured to generate a high intensity electric field to electrostatically atomize the water supplied to the discharge electrode (2). The discharge electrode (2) and the high voltage supply (4) are held by an identical circuit substrate (5).

In an embodiment, the water feeder (3) comprises a heat exchanger (6), and a heat-dissipating electrical conductor (7). The heat exchanger (6) is configured to cool the discharge electrode (2) to generate dew condensation water to be electrostatically atomized on part of the discharge electrode (2) based on air moisture. The heat-dissipating electrical conductor (7) is configured to conduct electricity to the heat exchanger (6) and also to dissipate heat.

In an embodiment, the discharge electrode (2) and the heat exchanger (6) constitute an electrostatic atomization generator (8). The electrostatic atomization generator (8) is held by the circuit substrate (5) with the heat-dissipating electrical conductor (7) fixed to the circuit substrate (5).

In an embodiment, electrical conductors of the high voltage supply (4) are fixed to the circuit substrate (5).

In an embodiment, a blower (9) configured to cool the heat-dissipating electrical conductor (7) is held by the circuit substrate (5).

In an embodiment, electrical conductors of the blower (9) are fixed to the circuit substrate (5).

In an embodiment, the circuit substrate (6) is housed in a case (60). The case (60) is provided with a hole (61) through which air is admitted into the case, and an injection hole (12) through which electrically charged particulate water generated by electrostatic atomization is allowed to be discharged, wherein the hole (61) faces the injection hole (12).

In an embodiment, the circuit substrate (5) is housed in a case (60). The case (60) is provided with a hole (61) through which air is admitted into the case, and an injection hole (12) through which electrically charged particulate water generated by electrostatic atomization is allowed to be discharged, wherein the hole (61) faces the injection hole (12). The electrostatic atomization generator (8) comprising the discharge electrode (2) and the heat exchanger (6); the blower (9); and the high voltage supply (4) are held by the circuit substrate (5) on a straight line joining the hole (61) through which air is admitted into the case, and the injection hole (12).

In an embodiment, a temperature or humidity sensor (70) is disposed on the circuit substrate (5), which is the same as that of the electrostatic atomization generator (8), in a blowing path from the blower (9) to the electrostatic atomization generator (8). A cooling power of the heat exchanger (6) is controlled based on temperature or humidity detected with the temperature or humidity sensor.

In the invention, the discharge electrode and the high voltage supply are held by the identical circuit substrate and unified. As a result, it is possible to facilitate assembly into the case, an electrical apparatus or the like, and to enable downsizing.

### BRIEF DESCRIPTION OF DRAWINGS

Preferred embodiments of the invention will now be described in further details. Other features and advantages of the present invention will become better understood with regard to the following detailed description and accompanying drawings where:

FIG. 1 is a perspective view of an electrostatic atomizing apparatus in accordance with an embodiment of the present invention;

FIG. 2A is a plan view of the embodiment, FIG. 2B is a side view thereof, and FIG. 2C is a front view thereof;

FIG. 3 is a sectional view of the embodiment;

FIG. 4 is a plan view of a circuit substrate in the embodiment;

FIG. 5 shows an electrostatic atomization generator in the embodiment, FIG. 5A is a perspective view thereof, FIG. 5B is a front view thereof, and FIG. 5C is a sectional view taken along an A-A line;

FIG. 6 is a perspective view of another embodiment;

FIG. 7A is a plan view of the embodiment, FIG. 7B is a side view thereof, and FIG. 7C is a front view thereof;

FIG. 8 is a plan view of a circuit substrate in the embodiment;

FIG. 9 shows an embodiment, FIG. 8A is a perspective view thereof as seen from above, and FIG. 8B is a perspective view thereof as seen from below;

FIG. 10A is a plan view of the embodiment, FIG. 10B is a side view thereof, and FIG. 10C is a front view thereof;

FIG. 11 is a sectional view taken along a B-B line in FIG. 10A;

FIG. 12 is a sectional view taken along a C-C line in FIG. 10B;

FIG. 13 is a sectional view of an embodiment;

FIG. 14 is a sectional view of an embodiment;

FIG. 15 is a sectional view of an embodiment;

FIGS. 16A and 16B are sectional views of an embodiment; and

FIG. 17 is a sectional view of an embodiment.

### DESCRIPTION OF EMBODIMENTS

Embodiments of the invention are explained with reference to the accompanying drawings.

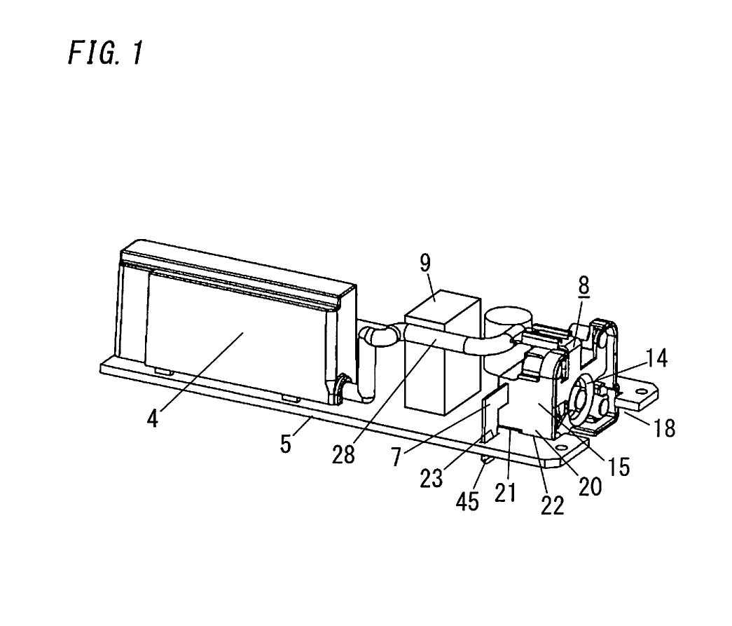

FIGS. 1 to 5 show an embodiment.

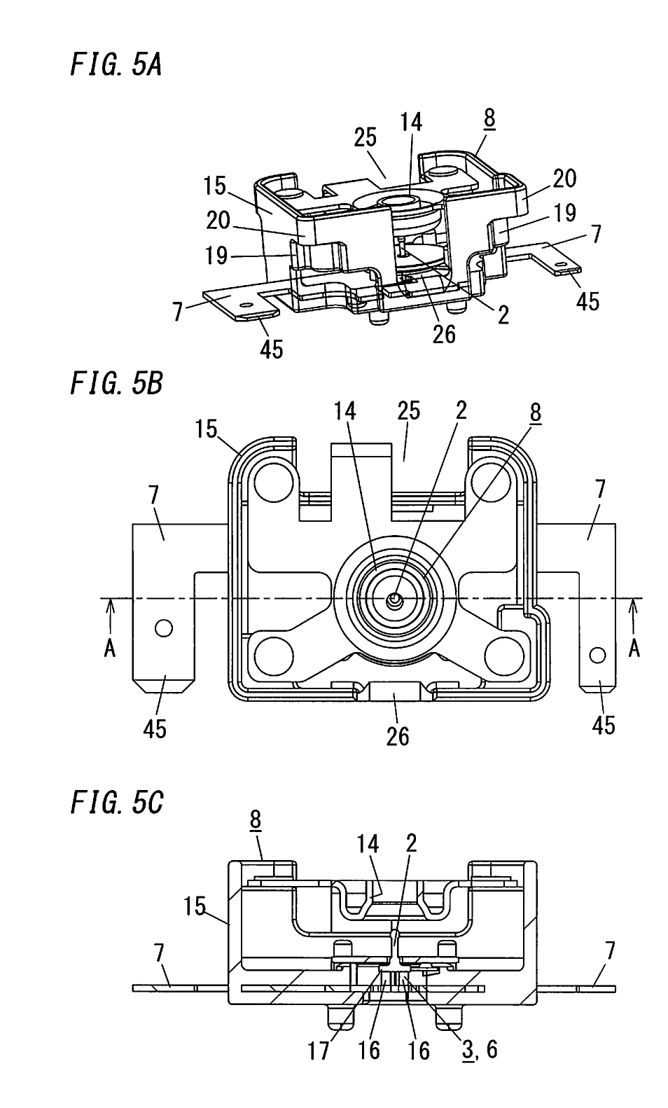

As shown in FIGS. 1 and 5C, an electrostatic atomizing apparatus 1 includes a discharge electrode 2, a water feeder 3, a high voltage supply 4 and a blower 9. The atomizer further includes a circuit substrate 5 having circuits for conducting electricity to the water feeder 3, the high voltage supply 4 and the blower 9.

The water feeder 3 is configured to supply water to the discharge electrode 2. In the embodiment, as shown in FIG. 5C, the water feeder 3 includes a heat exchanger 6 configured to cool the discharge electrode 2 to generate dew condensation water to be electrostatically atomized on part of the discharge electrode 2 based on air moisture.

The discharge electrode 2, and the heat exchanger 6 as the water feeder 3 are embedded in a (an atomization) casing 15 and consolidated into a block as shown in FIGS. 5A to 5C, thereby constituting one electrostatic atomization generator 8.

The casing 15 is made from synthetic resin. An example having a counter electrode 14 is shown in the embodiment of FIG. 5C.

The counter electrode 14 is shaped like a ring, of which center is arranged on an extended line of an axis of the discharge electrode 2.

The heat exchanger 6 includes thermoelectric devices 16. In FIG. 5C, a P-type Peltier element and an N-Type Peltier element are employed as the thermoelectric devices 16. Ends of the P-type Peltier element and the N-Type Peltier element are fixed on a back face of a coupler 17 which is made of electrical conductive material and shaped like a flat plate. Ends of the Peltier elements on a side of the coupler 17 (upper ends in FIG. 5C) are a cooling side, and other ends of the Peltier elements (lower ends in FIG. 5C) are a heat dissipation side.

The discharge electrode 2 having a sharp end is protruded from a front face of the coupler 17. The discharge electrode 2 is cooled by cooling the cooling side of the heat exchanger 6.

Two heat-dissipating electrical conductors 7 each of which is configured to conduct electricity and also to dissipate heat are joined to both ends of the paired P-type and N-type thermoelectric devices 16 on the heat dissipation side. As shown in FIGS. 5A to 5C, the heat-dissipating electrical conductors 7 are protruded outside the casing 15.

Each heat-dissipating electrical conductor 7 has a function to dissipate heat and a function to conduct electricity to the thermoelectric devices 16.

In the embodiment shown in FIGS. 5A and 5B, the heat-dissipating electrical conductors 7 each of which is shaped like an L are protruded from both sides of the casing 15. As a result, lengths thereof protruding laterally from the sides can be shortened as much as possible and wider heat-dissipation areas can be secured. Tip ends of the heat-dissipating electrical conductors 7 are connection terminals 45.

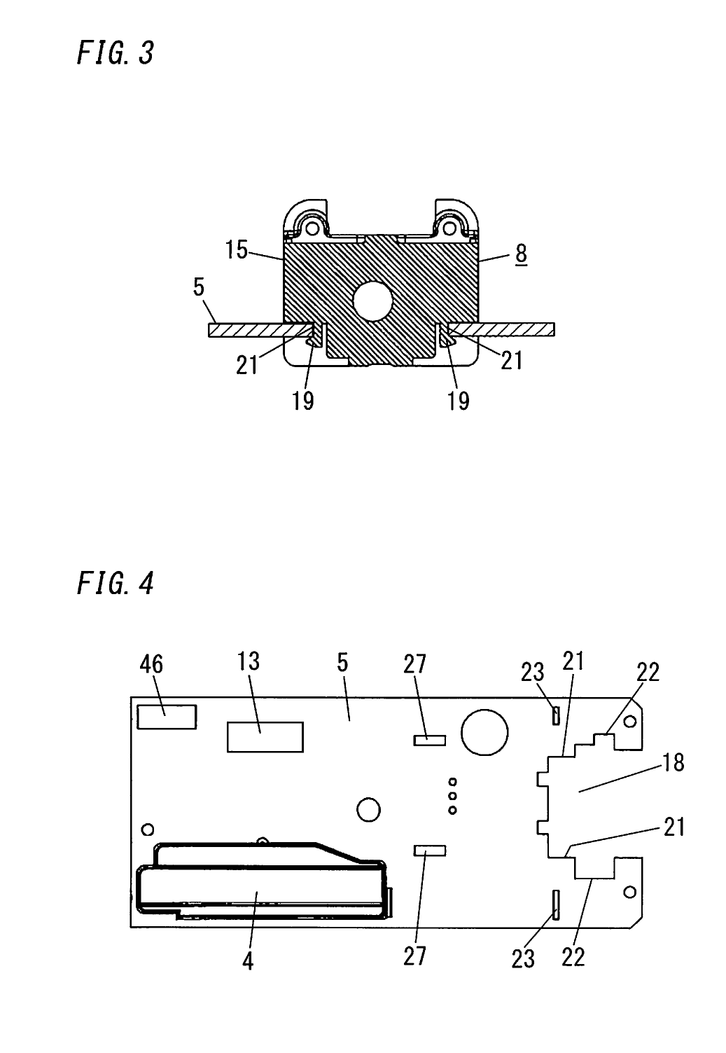

As shown in FIGS. 3 and 5A, locking structures 19 and displacement preventing structures 20 are provided at both sides of the casing 15 from which the heat-dissipating electrical conductors 7 are protruded.

An end of the casing 15 on a side of the counter electrode 14 (a front side in FIG. 5B) is opened. An air intake opening 25 is also provided in an upper face of the casing, and a drain opening 26 is provided in a lower face thereof. The lower face and the upper face of the atomization casing 15 are specified by defining sides of the tips of the L-shaped heat-dissipating electrical conductors 7 as downward, and defining sides of protrusion bases of the heat-dissipating electrical conductors 7 as upward.

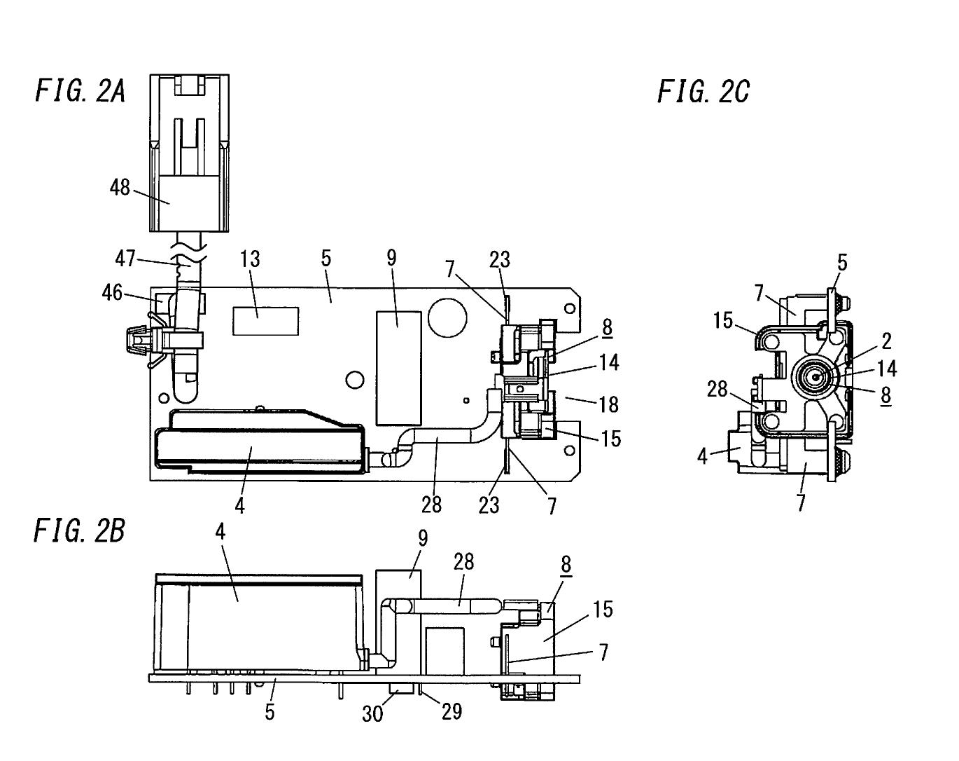

As shown in FIGS. 1 and 2A to 2C, the electrostatic atomization generator 8 including the discharge electrode 2 and the heat exchanger 6, and the high voltage supply 4 are held by the same circuit substrate 5. A power supply 13 configured to supply electrical power to the heat exchanger 6 as the water feeder 3, and the blower 9 are also held by the circuit substrate 5.

As shown in FIG. 4, a power input terminal 46 is mounted on the circuit substrate 5. The power input terminal 46 is configured to be connected with a power line 47 having a connector 48 for supplying external electrical power. The power input terminal 46 mounted on the circuit substrate 5 is electrically connected with the high voltage supply 4, the power supply 13, the blower 9 and the like, which are held by the circuit substrate 5, through the circuits formed on the circuit substrate 5.

As shown in FIG. 4, the circuit substrate 5 has a cut 18 which is shaped like a C in one end of the circuit substrate, and includes two locking edges 21 and two fitted recesses 22 on both side edges of the cut 18.

The circuit substrate 5 has two connection holes 23 through which the connection terminals 45 of the two heat-dissipating electrical conductors 7 are connected to the circuit substrate. An electrical conductor circuit for heat exchanger (not shown) provided in the circuit substrate 5 (parts of conductor patterns) is extended in inner faces of the connection holes 23. The electrical conductor circuit for heat exchanger is electrically connected with electrical parts forming the power supply 13 held by the circuit substrate 5 (mounted thereon in the embodiment).

As shown in FIGS. 2A and 2C, the connection terminals 45 are fitted into the connection holes 23 of the circuit substrate 5. The connection terminals 45 are then fixed with solder or the like so that the connection terminals 45 are electrically connected with the electrical conductor circuit for heat exchanger, and thereby the electrostatic atomization generator 8 is connected to and mounted on the circuit substrate 5.

Thus, the electrostatic atomization generator 8 is held by the circuit substrate 5.

In this case, as shown in FIG. 1, part (lower part) of the electrostatic atomization generator 8 is fitted into the cut 18 of the circuit substrate 5. The locking structures 19 then engages with the locking edges 21 (see FIG. 3) while the displacement preventing structures 20 are fitted into the fitted recesses 22.

The locking structures 19 engage with the locking edges 21 of the circuit substrate 5, thereby preventing the electrostatic atomization generator 8 from coming off in a direction (a vertical direction) perpendicular to surfaces of the circuit substrate 5.

In addition, the two displacement preventing structures 20 of the casing 15 are fitted into the two fitted recesses 22 of the circuit substrate 5, thereby preventing the electrostatic atomization generator 8 from being displaced in directions (a front-back direction and a crosswise direction) parallel with the surfaces of the circuit substrate 5.

In the embodiment, the electrostatic atomization generator 8 is firmly held by the circuit substrate 5 as a result of holding by locking the locking structures 19 and the locking edges 21 together and fitting the displacement preventing structures 20 into the fitted recesses 22 in addition to holding by fitting and connecting the connection terminals 45 into the connection holes 23.

As shown in FIG. 1, the high voltage supply 4 is held by the circuit substrate 5. In the embodiment shown in the accompanying drawings, terminals as electrical conductors of electrical parts forming the high voltage supply 4 are fixed to the circuit substrate 5.

As shown in FIGS. 1 and 2A to 2C, the high voltage supply 4 and the counter electrode 14 of the electrostatic atomization generator 8 are electrically connected through a harness 28.

The blower 9 configured to cool the heat-dissipating electrical conductors 7 is held by the circuit substrate 5 (see FIGS. 1 and 2A to 2C). In the embodiment of the accompanying drawings, terminals 29 as electrical conductors of a fan unit forming the blower 9 are connected to the circuit substrate 5. The terminals 29 are electrically connected to an electrical conductor circuit for blower (conductor patterns) provided in the circuit substrate 5.

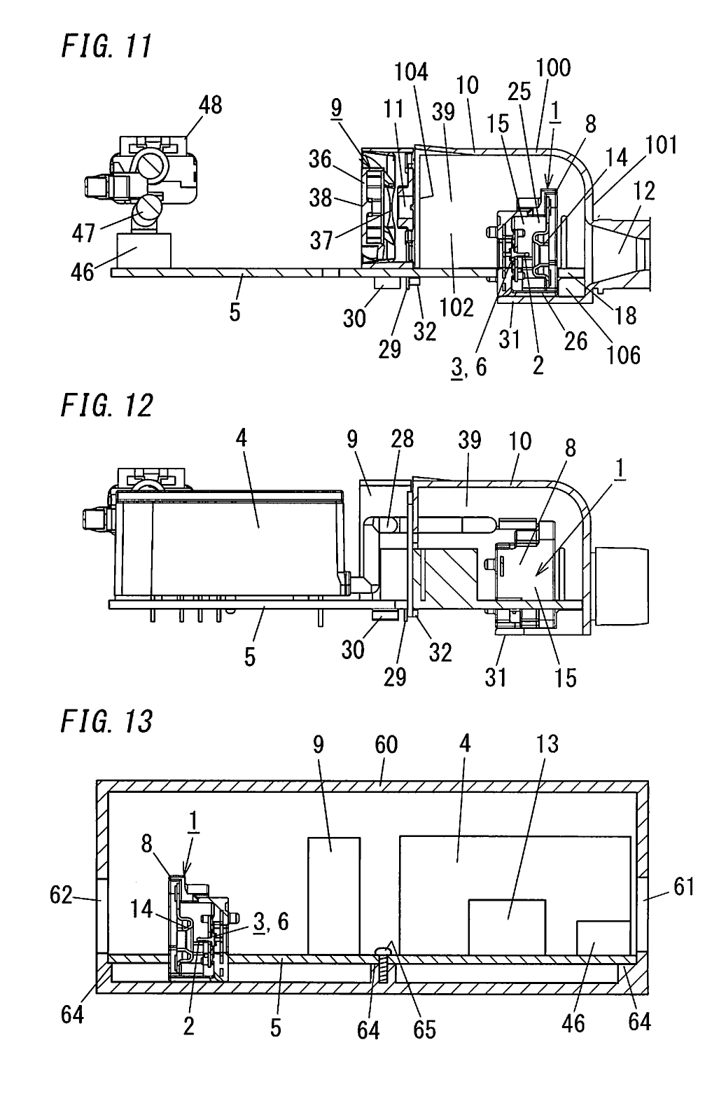

The blower 9 includes a fan, a vent and an air-intake (see FIG. 11 as stated below).

The blower 9 further includes two hooks 30. The hooks 30 are engaged with two holes 27 cut in the circuit substrate 5 (see FIG. 4), thereby improving holding force of the blower 9 by the circuit substrate 5.

In the electrostatic atomizing apparatus 1 configured as stated above, if the power supply 13 energizes the thermoelectric devices 16, the thermoelectric devices 16 conduct heat in one direction. Accordingly, the cooling sides of the thermoelectric devices 16 are cooled and the discharge electrode 2 is then cooled, while the heat dissipation sides thereof become hot and the heat-dissipating electrical conductors 7 then become hot.

If the discharge electrode 2 is cooled, air around the discharge electrode 2 is cooled. As a result, dew condensation water is formed from air moisture by dew formation on a tip of the discharge electrode 2.

The high voltage supply 4 applies a high voltage to the discharge electrode 2 to generate a high intensity electric field around it in a state where the dew condensation water is held on the tip of the discharge electrode 2 by cooling the discharge electrode 2. The water held on the tip of the discharge electrode 2 is then charged negative or positive, and Coulomb's force acts on the charged water. A liquid surface thereof is locally raised and shaped like a cone, thereby forming a Taylor cone. The charge then concentrates on a tip of the water shaped like the cone, thereby having a high density. The water is split and scattered by bursting by repulsive force of the high density charge (Rayleigh fission), thereby generating electrostatic atomization and producing electrically charged particulate water the size of nanometers having radicals.

On the other hand, the heat-dissipating electrical conductors 7 dissipate heat.

The blower 9 is energized and starts operating while at the same time the power supply 13 energizes the thermoelectric devices 16.

A current of air from the blower 9 flows along the casing 15 and strikes the heat-dissipating electrical conductors 7 to cool the heat-dissipating electrical conductors 7 and thereby to facilitate heat dissipation, and then flows forward.

The electrically charged particulate water generated by electrostatic atomization in the casing 15 is carried outside a front opening of the casing 15 by an ionic wind generated by the electrostatic atomization, and a little current of air admitted into the casing 15 from the air intake opening 25. The electrically charged particulate water carried outside the front opening of the casing 15 merges with the current of air which has flowed outside the casing 15, and is then carried on the current of air to be discharged forward. As a result, the electrically charged particulate water can be carried in a long distance.

Air volume admitted into the casing 15 from the air intake opening 25 is set so as not to disturb that dew condensation water is formed from air moisture around the discharge electrode 2. As a result, time necessary to dew formation can be shorthand and dew condensation water can be formed stably.

In the electrostatic atomizing apparatus 1 configured as stated above, the electrostatic atomization generator 8 including the discharge electrode 2 and the water feeder 3; the high voltage supply 4; the power supply 13; the blower 9; and the like are held by the circuit substrate 5 to be consolidated into one unit. That is, the configuration thereof is simplified, thereby enabling downsizing.

Moreover, the water feeder 3 is formed of the heat exchanger 6, and the heat-dissipating electrical conductor 7 has the functions of conducting electricity to the heat exchanger 6 and dissipating heat. It is therefore unnecessary to form the functions of conducting electricity to the heat exchanger 6 and dissipating heat by separate members. Therefore, the configuration thereof is simplified. In this regard, the electrostatic atomizing apparatus 1 can be miniaturized.

In the embodiment, the heat-dissipating electrical conductors 7 of the heat exchanger 6 as the water feeder 3 are fixed to the circuit substrate 5. Therefore, a harness for energizing the heat exchanger 6 is unnecessary, and the configuration and assembling thereof are simplified.

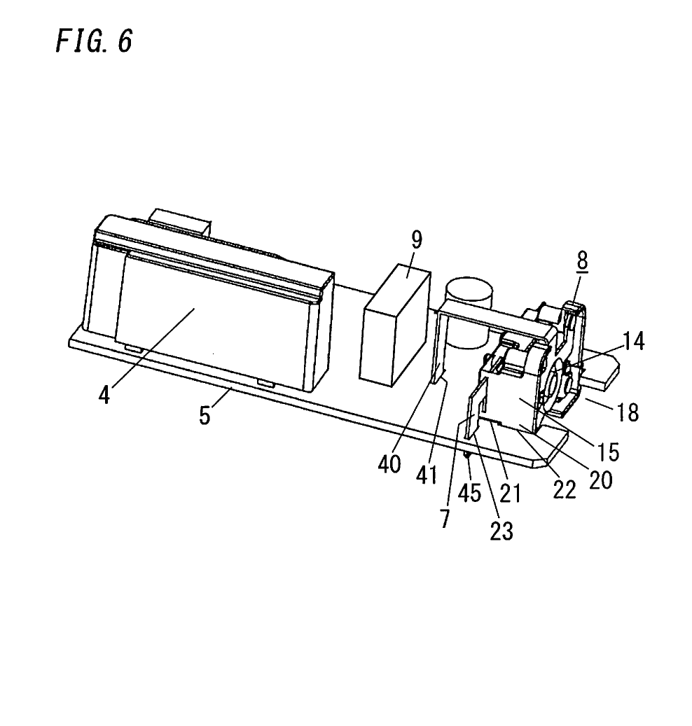

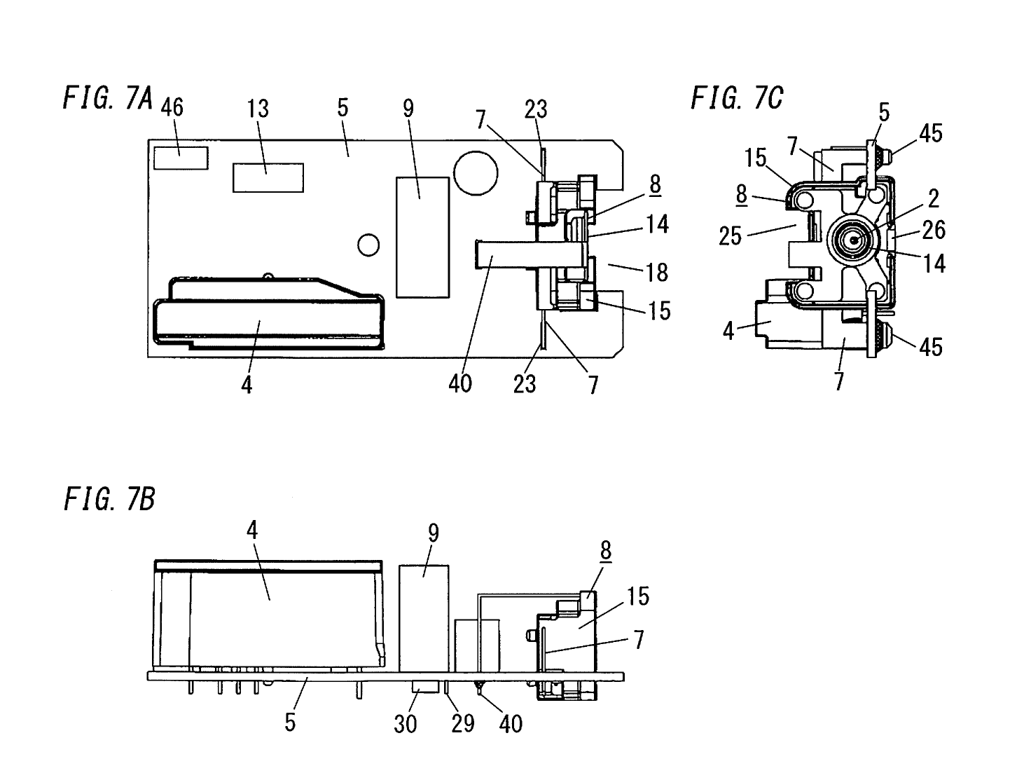

FIGS. 6 and 7 show another embodiment.

A configuration of an electrical connection between a counter electrode 14 and a high voltage supply 4 in the present embodiment differs from the configuration that as described above the high voltage supply 4 and the counter electrode 14 of the electrostatic atomization generator 8 are electrically connected via the harness 28. The present embodiment is configured like the previous embodiment except for the electrical connection between the high voltage supply 4 and the counter electrode 14. In the present embodiment, features thereof are mainly explained by omitting redundant explanation.

In the present embodiment, as shown in FIGS. 6 and 7, a terminal 40 is integrally extended from the counter electrode 14 provided in an electrostatic atomization generator 8.

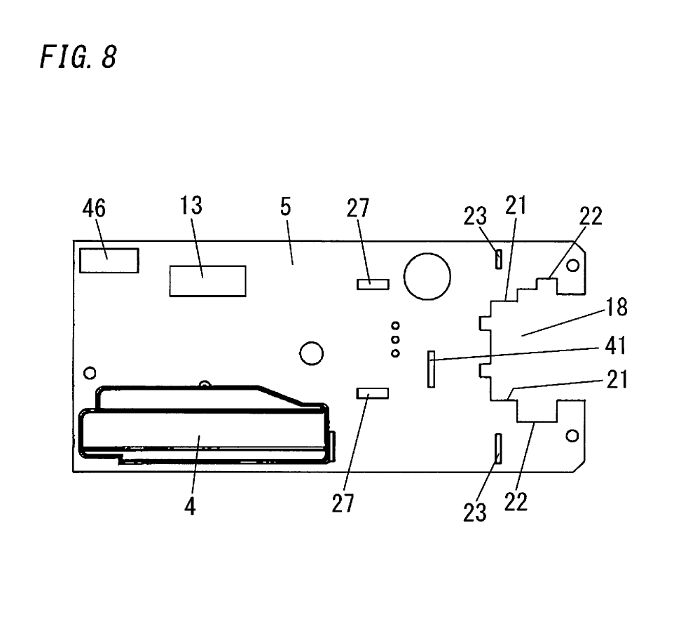

In addition, a circuit substrate 5 has a circuit for high voltage supply formed therein and a connection hole 41 for connecting the terminal 40 of the counter electrode 14 to the circuit substrate 5 as shown in FIG. 8. The circuit for high voltage supply formed in the circuit substrate 5 (part of a conductor pattern) is extended in an inner face of the connection hole 41. The circuit for high voltage supply is electrically connected to electrical parts constituting the high voltage supply 4 held by (in the embodiment, mounted on) the circuit substrate 5.

The terminal 40 integrally extended from the counter electrode 14 is fitted into the connection hole 41 of the circuit substrate 5 and then connected and fixed to the circuit substrate 5 with solder or the like so that the terminal 40 is electrically connected with the circuit for high voltage supply, and is thereby fixed to the circuit substrate 5.

Thus, the terminal 40 of the counter electrode 14 provided in the electrostatic atomization generator 8 is fixed to the circuit substrate 5. The harness 28 in the previous embodiment is accordingly unnecessary, which connects the high voltage supply 4 and the counter electrode 14 of the electrostatic atomization generator 8. As a result, the configuration of the present embodiment can be simplified, thereby enabling downsizing.

In addition, the terminal 40 of the counter electrode 14 provided in the electrostatic atomization generator 8 is fixed to the circuit substrate 5, thereby providing a mechanical connection in part of the terminal 40.

In the embodiment, the electrostatic atomization generator 8 is more firmly held as a result of holding by fixing the terminal 40 of the counter electrode 14 to the circuit substrate 5 in addition to: holding by fixing connection terminals 45 of heat-dissipating electrical conductors 7 thereto; and holding by locking the locking structures 19 and locking edges 21 together and fitting the displacement preventing structures 20 into fitted recesses 22.

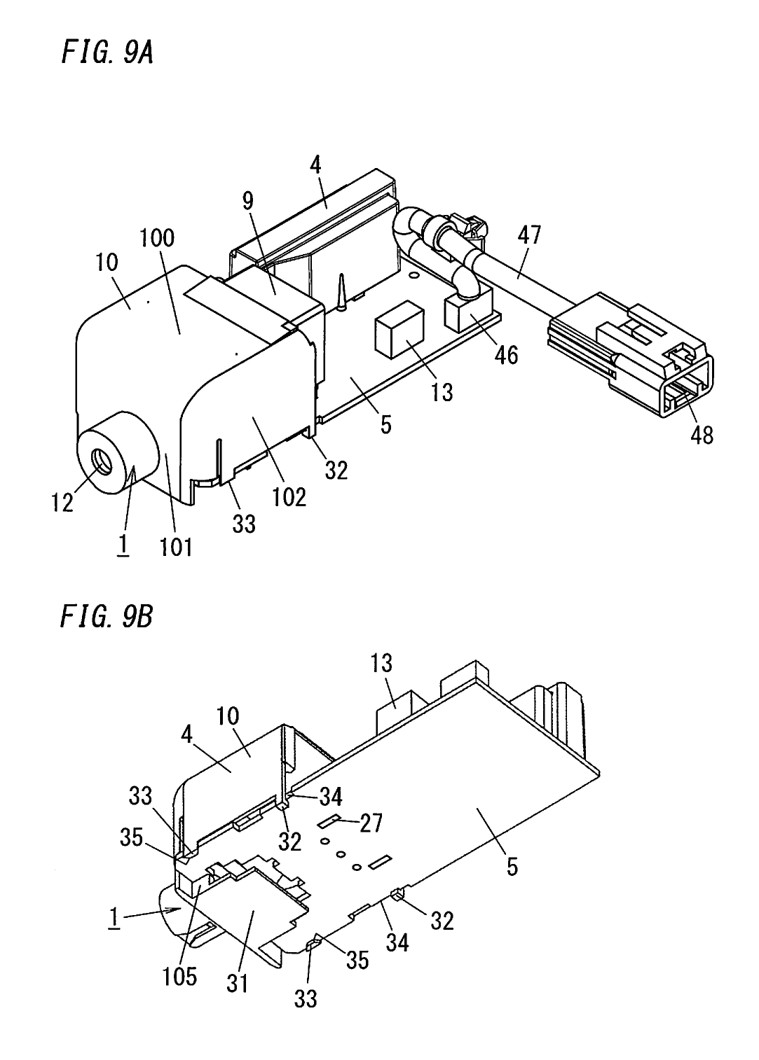

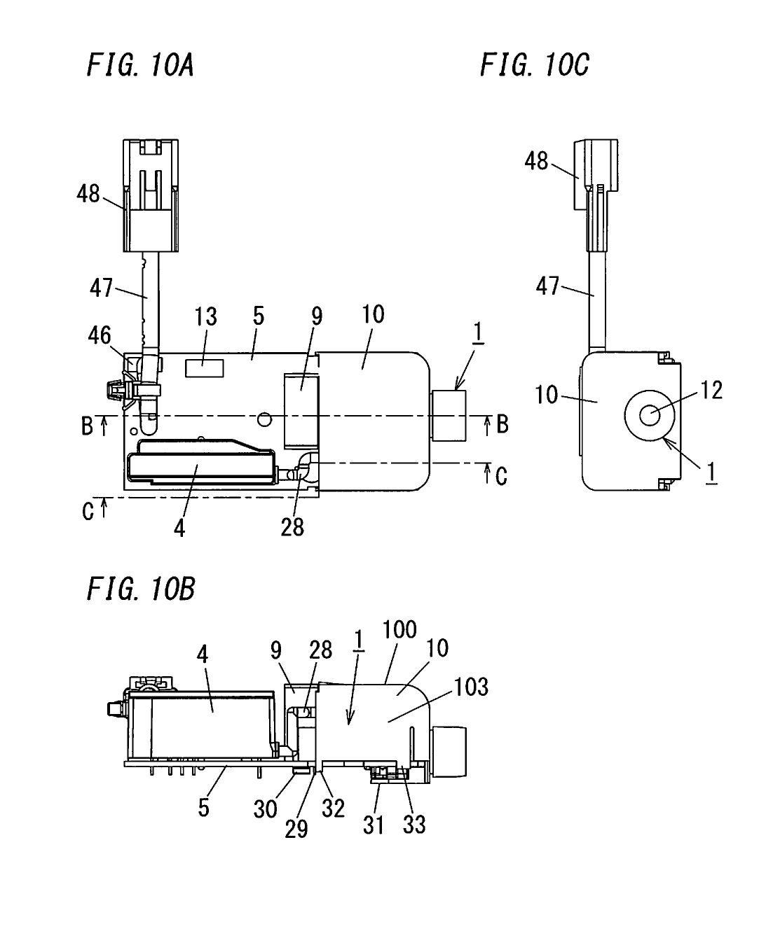

FIGS. 9 to 12 show one more embodiment.

The present embodiment is basically configured like each of the previous embodiments, but differs therefrom in that a cover 10 which is made from synthetic resin and has electric insulation is held by a circuit substrate 5.

The cover 10 held by the circuit substrate 5 covers an electrostatic atomization generator 8 including a discharge electrode 2 and a heat exchanger 6, or a blower 9 as well as the electrostatic atomization generator 8 including the discharge electrode 2 and the heat exchanger 6. In short, the cover 10 covers at least the discharge electrode 2 and a water feeder 3 (the heat exchanger 6), of the discharge electrode 2, the water feeder 3 and the blower 9.

In the present embodiment, the cover 10 covers the electrostatic atomization generator 8 including the discharge electrode 2 and the heat exchanger 6. That is, the discharge electrode 2 and the water feeder 3 are covered with the cover 10.

As shown in FIG. 11, an air-intake 11 is formed in a back of the cover 10, and a barrel is protruded from a front end of the cover 10 and has therein an injection hole 12 configured to emit electrically charged particulate water.

As shown in FIG. 9B, a bottom of the cover 10 is opened with a front of the cover 10 extended downward. A bottom cover 31 is protruded backward from a lower end center of the bottom.

A locking nail 32 and a displacement preventing projection 33 are provided at each of both sides of the bottom of the cover 10.

The cover 10 is attached to the circuit substrate 5 as a result of locking the two locking nails 32 and locking recesses 34 of the circuit substrate together and fitting the two displacement preventing projections 33 into fitted recesses 35 of the circuit substrate (see FIGS. 9A and 1B).

The locking nails 32 and the locking recesses 34 are locked together, and it is accordingly possible to prevent the cover 10 from coming off in a direction (a vertical direction) perpendicular to surfaces of the circuit substrate 5.

The two displacement preventing projections 33 of the cover 10 are fitted into the two fitted recesses 35 of the circuit substrate 5, and it is accordingly possible to prevent the cover 10 from being displaced in directions (a front-back direction and a crosswise direction) parallel with the surfaces of the circuit substrate 5.

The bottom cover 31 covers lower part of the electrostatic atomization generator 8 which is fitted into a cut 18 of the circuit substrate 5 and protrudes downward (see FIGS. 9B, 10B, 11 and 12).

Thus, the cover 10 is attached to and held by the circuit substrate 5, thereby almost sealing a space 39 enclosed with the cover 10 and the circuit substrate 5 except for the air-intake 11 and the injection hole 12. The electrostatic atomization generator 8 is disposed in the space 39. That is, as shown in FIGS. 9A, 2B and 11, the circuit substrate 5 is shaped like a rectangle and has the cut 18 shaped like a C on a first end of the circuit substrate in a longer direction thereof. On the other hand, the cover 10 is shaped like a case having a base 100 and four sides 101-104, and has an opening facing the base 100. As shown in FIG. 11, the cover 10 is attached to the circuit substrate 5 so as to have an opening corresponding to only the cut 18 (hereinafter referred to as a “remaining opening”) with the opening of the cover 10 shut with a side of the first end of the circuit substrate 5. The aforementioned injection hole 12 is formed in the side 101 which is in contact with an edge of the first end of the circuit substrate 5, while the air-intake 11 is formed in the side 104 which faces the side 101. Accordingly, the electrostatic atomization generator 8 can be disposed in the space which is formed of the cover 10 and the circuit substrate 5 and is almost sealed except for the air-intake 11 and the injection hole 12. In the present embodiment, the space has only openings of the air-intake 11 and the injection hole 12. That is, as shown in FIGS. 9B and 11, the side 101 of the cover 10 is longer than the sides 102-104 which are in contact with a first surface of the circuit substrate 5, and protrudes toward a direction from the first surface to a second surface of the circuit substrate 5. The aforementioned bottom cover (a second cover) 31 is extended from an end of the side 101 toward the side 104. The discharge electrode 2 and the water feeder 3 (i.e., the heat exchanger 6) are housed in the casing 15. As shown in FIG. 11, a bottom of the housing 15 is in contact with an inner face of the second cover 31 so as to close a base side (a second end side of the circuit substrate 5 in the longer direction) of the remaining opening. As shown in FIGS. 9B and 11, two flats 105 and 106 are protruded from the inner face of the second cover 31 and an inner face of the side 101 and are in contact with the second surface of the circuit substrate 5 and the casing 15, thereby covering an end side (the first end side of the circuit substrate 5) of the remaining opening.

As shown in FIG. 11, the side 104 (the back) of the cover 10 faces a front of the blower 9 with the back in contact with the front, and the air-intake 11 faces a vent 37 of the blower 9.

In the present embodiment, the blower 9 is activated when the electrostatic atomization is operated, thereby sending a current of air from the air-intake 11 into the space 39 which is enclosed with the cover 10 and the circuit substrate 5 and in which the electrostatic atomization generator 8 is disposed.

The current of air sent into the space 39 strikes the heat-dissipating electrical conductors 7 to cool the heat-dissipating electrical conductors 7 and thereby to facilitate heat dissipation, while flowing along a gap between the casing 15 and sides and the base (a top) of the cover 10, and then flows forward from the injection hole 12.

An area surface of the gap between the casing 15 and the sides and the base of the cover 10 is set to be larger than an area surface of an air intake opening 25. It is therefore possible to effectively cool the heat-dissipating electrical conductors 7, because air from the blower 9 slightly flows into the casing 15 and mainly flows through the gap between the casing 15 and the sides and the base of the cover 10.

On the other hand, the electrically charged particulate water generated by electrostatic atomization in the casing 15 is carried outside a front opening of the casing 15 by an ionic wind generated by the electrostatic atomization, and a little current of air admitted into the casing 15 from the air intake opening 25. The electrically charged particulate water carried outside the front opening of the casing 15 merges with the current of air which has flowed through the gap between the casing 15 and the sides and the base of the cover 10, and is thereby discharged forward from the injection hole 12. As a result, the electrically charged particulate water can be carried in a long distance.

Air volume admitted into the casing 15 from the air intake opening 25 is set so as not to disturb that the discharge electrode 2 is cooled, thereby forming dew condensation water from air moisture. As a result, time necessary to dew formation can be shortened and dew condensation water can be formed stably.

The electrostatic atomization generator 8 is covered with the cover 10 held by the circuit substrate 5, and it is accordingly to prevent contact between high voltage part thereof and a person's finger or other things by mistake.

Since the air-intake 11 faces the blower 9, air from the blower 9 can be effectively sent into the space 39 which is enclosed with the cover 10 and the circuit substrate 5 and in which the electrostatic atomization generator 8 is disposed.

The space 39 in which the electrostatic atomization generator 8 is disposed is almost sealed except for the air-intake 11 and the injection hole 12. Therefore, air which is sent from the blower 9 to be pressured can suppress a pressure loss caused by leakage to reach the injection hole 12, thereby being discharged to the ambient air. As a result, the electrically charged particulate water can be carried in a long distance.

The air-intake 11 is set to have almost the same size as the vent 37 of the blower 9 facing the air-intake. Therefore, all air from the blower 9 can be sent into the space 39 and air can be prevented from flowing backward from a gap between the blower 9 and the cover 10. As a result, the air can flow toward the injection hole 12 without decreasing the pressure of the blower 9.

When the electrostatic atomizing apparatus 1 configured as stated above is used, the electrostatic atomizing apparatus 1 is built in an enclosure or any of various apparatuses with a drain opening 26 side down. The drain opening 26 is provided in a lower face of the casing 15 of the electrostatic atomization generator 8.

Accordingly, even if excessive dew condensation water drops from the discharge electrode 2 as a result of cooling the discharge electrode 2 to generate dew condensation water, it flows downward from the drain opening 26 and is then received with the bottom cover 31.

Therefore, even if the excessive dew condensation water drops downward, it is possible to prevent the water from flowing on the circuit substrate 5 as well as trouble on the circuit substrate 5 by the dew condensation water.

The water received with the bottom cover 31 naturally evaporates, and it is accordingly possible to prevent the water from exceeding the bottom cover 31 to flow. The bottom cover 31 is made from synthetic resin and has electric insulation. Even if an enclosure case or attachment part of the electrostatic atomizing apparatus 1 in an apparatus is made of metal, the bottom cover 31 intervenes between the dropped dew condensation water and the metal, thereby securing electric insulation.

Another embodiment is explained with reference to FIG. 13.

The present embodiment shows an example in which, as described above, a circuit substrate 5 is configured as one unit by holding: an electrostatic atomization generator 8 including a discharge electrode 2 and a water feeder 3; a high voltage supply 4; a power supply 13; a blower 9; and the like, and is housed in a case 60.

The example of the figure shows that the circuit substrate 5 holds the electrostatic atomization generator 8, the high voltage supply 4, the power supply 13, the blower 9 and the like as shown in FIGS. 1 and 2 and is thereby configured to be one unit which is housed in the case 60.

In this case, the case 60 forms an envelope of an electrostatic atomizing apparatus 1. The case 60 houses the circuit substrate 5 which holds the electrostatic atomization generator 8, the high voltage supply 4, the power supply 13, the blower 9 and the like and is thereby configured to be one unit. Therefore, assembling thereof becomes easy.

In the embodiment of FIG. 13, the circuit substrate 5 is supported by supports 64 provided in the case 60 and fixed with a fixing member 65.

When the case 60 is made of electrically conducting material such as metal, the fixing member 65 fixing the circuit substrate 5 to the case 60 can double as earth and reduce electric noises caused by electrical discharges of the electrostatic atomization generator 8.

In the case 60, a hole 61 through which air is admitted into the case faces an injection hole 62 for electrically charged particulate water generated by electrostatic atomization. Air admitted into the case 60 from the hole 61 cools the high voltage supply 4, the power supply 13 and heat-dissipating electrical conductors 7, thereby reducing generation of heat from electrical parts thereof. As a result, overall miniaturization can be realized, because electrical parts having lower capacity can be chosen.

The circuit substrate 5 may hold a cover 10 (not shown in the figure) and housed in the case 60 as described above.

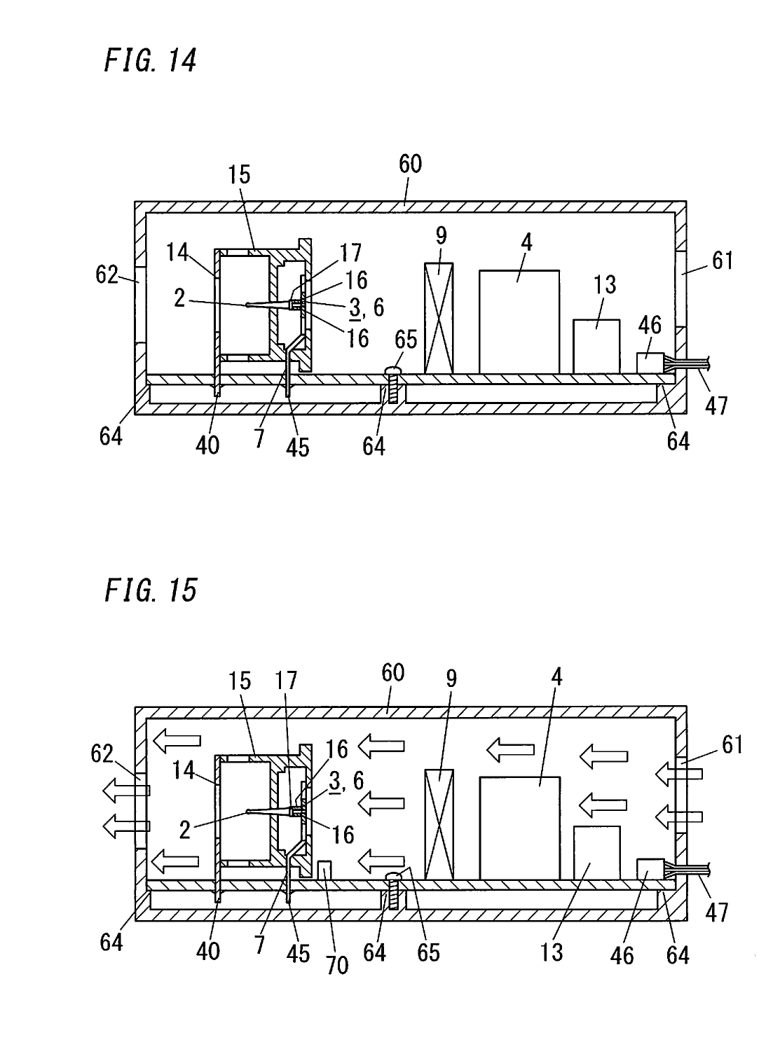

As shown in FIG. 14, the electrostatic atomization generator 8, the high voltage supply 4, the power supply 13, the blower 9 and the like may held in a line by the circuit substrate 5 housed in the case 60. The electrostatic atomization generator 8, the high voltage supply 4, the power supply 13, the blower 9 and the like may be arranged in a line on a straight line joining the hole 61 and the injection hole 62 provided in the case 60. As shown in arrows of FIG. 15, air flows in the case 60 from the hole 61 and then flows out from the injection hole 62. It is accordingly possible to more effectively reduce generation of heat from electrical parts held by the circuit substrate 5.

In the example of FIGS. 14 and 15, the circuit substrate 5 holds a row of the electrostatic atomization generator 8, the blower 9, the high voltage supply 4 and the power supply 13 arranged in this order. Thus, the electrostatic atomization generator 8 is disposed at a downstream end but the order of the others, namely the blower 9, the high voltage supply 4 and the power supply 13 is not limited.

As shown in FIG. 15, a temperature or humidity sensor 70 may be mounted between a holding position of the blower 9 and a holding position of the electrostatic atomization generator 8 in the circuit substrate 5.

A cooling capacity of the heat exchanger 6 may be controlled based on temperature or humidity detected with the temperature or humidity sensor 70. Thus, the temperature or humidity sensor 70 is mounted between the blower 9 and the electrostatic atomization generator 8 and measures temperature or humidity, which differs from temperature or humidity near the discharge electrode 2 but the difference can be reduced. It is therefore possible to suppress excessive cooling or insufficient cooling of the discharge electrode 2 and to control cooling power of the heat exchanger 6 in response to an environment near the discharge electrode 2. As a result, dew condensation water can be effectively generated on the discharge electrode 2.

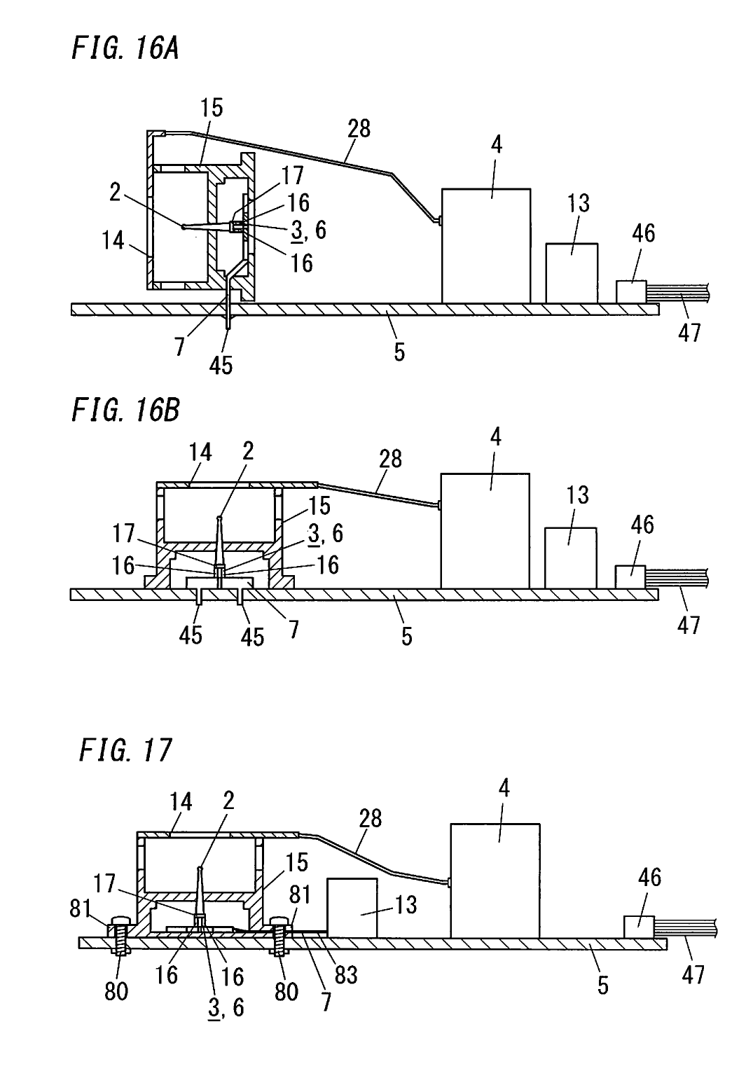

Each of the aforementioned embodiments shows an example in which a blower 9 is held by a circuit substrate 5, but a blower 9 needs not be held by a circuit substrate 5 as shown in FIGS. 16A, 16B and 17.

In any example of the aforementioned embodiments in which an electrostatic atomization generator 8 is held by a circuit substrate 5, at least one of each heat-dissipating electrical conductor 7 and a terminal 40 of a counter electrode 14 is connected to and held by a circuit substrate 5. However, an electrostatic atomization generator 8 may be held by a circuit substrate 5 with coupling members 80 as shown in FIG. 17.

In the embodiment of FIG. 17, a casing 15 of the electrostatic atomization generator 8 is provided with fixing flanges 81 that are fixed to a circuit substrate 5 with the coupling members 80. As a result, the electrostatic atomization generator 8 is held by the circuit substrate 5.

In this example, a high voltage supply 4 is electrically connected with a counter electrode 14 of the electrostatic atomization generator 8 through a harness 28. Heat-dissipating electrical conductors 7 of a heat exchanger 6 are electrically connected with a power supply 13 through a harness for discharge 83.

Each of the aforementioned embodiments shows an example in which a high voltage supply 4 applies a high voltage to a counter electrode 14. However, the high voltage supply 4 may apply a high voltage to a discharge electrode 2.

Each of the aforementioned embodiments shows an example in which a discharge electrode 2 and a heat exchanger 6 that is a water feeder 3 are housed in a casing 15 to be unified as one electrostatic atomization generator 8, and the electrostatic atomization generator 8 is held by a circuit substrate 5. However, blocks of the discharge electrode 2 and the water feeder 3 may be formed of individual bodies and held by the circuit substrate 5.

Although the present invention has been described with reference to certain preferred embodiments, numerous modifications and variations can be made by those skilled in the art without departing from the true spirit and scope of this invention, namely claims.

1. An electrostatic atomizing apparatus, comprising:
a discharge electrode;
a water feeder configured to supply water to the discharge electrode; and
a high voltage supply configured to generate a high intensity electric field to electrostatically atomize the water supplied to the discharge electrode,
wherein the discharge electrode and the high voltage supply are held by an identical circuit substrate.

2. The electrostatic atomizing apparatus of claim 1, wherein the water feeder comprises:
a heat exchanger configured to cool the discharge electrode to generate dew condensation water to be electrostatically atomized on part of the discharge electrode based on air moisture; and
a heat-dissipating electrical conductor configured to conduct electricity to the heat exchanger and also to dissipate heat.

3. The electrostatic atomizing apparatus of claim 2, wherein
the discharge electrode and the heat exchanger constitute an electrostatic atomization generator, and
the electrostatic atomization generator is held by the circuit substrate with the heat-dissipating electrical conductor fixed to the circuit substrate.

4. The electrostatic atomizing apparatus of claim 1, wherein electrical conductors of the high voltage supply are fixed to the circuit substrate.

5. The electrostatic atomizing apparatus of claim 2, wherein a blower configured to cool the heat-dissipating electrical conductor is held by the circuit substrate.

6. The electrostatic atomizing apparatus of claim 5, wherein electrical conductors of the blower are fixed to the circuit substrate.

7. The electrostatic atomizing apparatus of claim 1, wherein
the circuit substrate is housed in a case,
the case is provided with a hole through which air is admitted into the case, and an injection hole through which electrically charged particulate water generated by electrostatic atomization is allowed to be discharged, and
the hole faces the injection hole.

8-10. (canceled)

11. The electrostatic atomizing apparatus of claim 5, wherein
the circuit substrate is housed in a case,
the case is provided with a hole through which air is admitted into the case, and an injection hole through which electrically charged particulate water generated by electrostatic atomization is allowed to be discharged,
the hole faces the injection hole, and
the electrostatic atomization generator comprising the discharge electrode and the heat exchanger; the blower; and the high voltage supply are held by the circuit substrate on a straight line joining the hole through which air is admitted into the case, and the injection hole.

12. (canceled)

13. The electrostatic atomizing apparatus of claim 5, wherein
a temperature or humidity sensor is disposed on the circuit substrate, which is the same as that of the electrostatic atomization generator, in a blowing path from the blower to the electrostatic atomization generator,
a cooling power of the heat exchanger is controlled based on temperature or humidity detected with the temperature or humidity sensor.

14-16. (canceled)
